(19) United States
(12) Patent Application Publication
(10) Pub. No.: US 2025/0206592 A1
(43) Pub. Date: Jun. 26, 2025

(54) Ice Plunger for Beverage System

(71) Applicant: SharkNinja Operating LLC, Needham, MA (US)

(72) Inventors: August Drufke, Arlington, MA (US); Kara Gardiner, Boston, MA (US)

(21) Appl. No.: 18/393,074

(22) Filed: Dec. 21, 2023

(51) Int. Cl. B67D 1/08; F25C 5/182

(52) U.S. Cl. CPC B67D 1/0857; B67D 1/0801; F25C 5/182

(57) ABSTRACT

A housing defines a volume to retain a fluid. The housing defines an opening along a top of the housing to receive fluid. The housing also defines a separated fluid outlet. A lid is arranged to cover the opening. In some embodiments, the lid defines a hole therethrough. Within the reservoir is a plunger with a paddle. The paddle is arranged and configured to move and retain cold materials within the reservoir, such as ice, towards the outlet. The plunger can include a shaft extending through the hole. The shaft can be attached to a handle at a first end of the shaft. In some embodiments, the paddle can be coupled to a second end of the shaft positioned within the volume of the housing. The plunger can be vertically slidably movable through the hole to vertically move the paddle within the volume.

### TECHNICAL FIELD

This disclosure relates to an ice plunger for use in a beverage container.

### BACKGROUND

Conventional beverage dispensing devices operate to carbonate and/or flavor water. Some devices may mix carbonated water and a flavoring compound together in a machine and then dispense the resulting mixture into a receptacle. Still other devices rely on carbonating water within a specialized container to be attached to the device, and from which the resulting beverage is served. The container can be pre-filled with water and/or flavoring, and then it can be secured to the devices and pressurized within the container and used to serve the resulting beverage. These devices, however, can create excess plastic waste, as specially adapted bottles must be produced to interface with the device.

### SUMMARY

A reservoir for a beverage machine includes the following features. A housing defines a volume to retain a fluid. The housing defines an opening along a top of the housing to receive fluid. The housing can also define a separated fluid outlet, for example, at a bottom surface of the housing. A lid is arranged to cover the opening. In some embodiments, the lid can define a hole therethrough. Within the reservoir is a plunger with a paddle. The paddle is arranged and configured to move and retain cold materials within the reservoir, such as ice, towards the outlet. In some embodiments, the paddle can define a profile that is substantially parallel to an inner wall of the housing. Alternatively or in addition, the plunger can include a shaft extending through the hole. In such an embodiment, the shaft can be attached to a handle at a first end of the shaft, and the handle can be positioned above the lid. The handle can have a larger cross-sectional area than the hole. In some embodiments, the paddle can be coupled to a second end of the shaft positioned within the volume of the housing. The shaft can have a diameter less than that of the hole, allowing the plunger can be vertically slidably movable through the hole defined by the lid to vertically move the paddle within the volume.

In some embodiments, the paddle can define perforations, or holes, to reduce drag of the paddle as it is moved through the volume. For example, such holes or perforations can be between 4 millimeters and 6.5 millimeters.

In some embodiments, the reservoir includes a biasing mechanism configured to direct the plunger towards an outlet of the reservoir, such as the outlet at the bottom of the housing. This bias mechanism can include a weight within the shaft. The weight can be sufficient to produce or provide a downward force to the plunger that is greater than a buoyancy force of any cold material, such as ice, within the reservoir.

In some embodiments, the shaft includes an upper shaft and a lower shaft. The upper shaft can be connected to the handle previously described. The lower shaft can be connected to the paddle previously described. In some embodiments, the lower shaft can define a passage extending between the upper shaft and paddle. The lower shaft and the upper shaft can be attached or coupled to one another by a fastener. In some embodiments, the lower shaft is hollow and includes at least one defines a hole configured to break a vacuum or to release fluid from the passage.

### BRIEF DESCRIPTION OF DRAWINGS

These and other features will be more readily understood from the following detailed description taken in conjunction with the accompanying drawings, in which:

FIG. 1A is a front view of one embodiment of a beverage dispensing device having a water reservoir coupled thereto;

FIG. 1B is a front perspective view of the beverage dispensing device of FIG. 1A, having the water reservoir removed;

FIG. 1C is a bottom perspective view of the beverage dispensing device of FIG. 1B;

FIG. 1D is a rear perspective view of the beverage dispensing device of FIG. 1B, having a door open to reveal a CO2 cavity;

FIG. 1E is a rear perspective view of the beverage dispensing device of FIG. 1B with a door removed to reveal a CO2 canister disposed within a canister cavity;

FIG. 2A is a front perspective view of a drip tray of the beverage dispensing device of FIG. 1A;

FIG. 2B is a front perspective view of the drip tray of FIG. 2A having a grate removed;

FIG. 3A is a front perspective view of a reservoir valve seat of the beverage dispensing device of FIG. 1A;

FIG. 3B is a side perspective cross-sectional view of the reservoir valve seat of FIG. 3A;

FIG. 4A is a front perspective view of the water reservoir of FIG. 1A;

FIG. 4B is a bottom perspective view of the water reservoir of FIG. 1A;

FIG. 4C is a side cross-sectional view of a valve section of the water reservoir of FIG. 1A;

FIG. 5A is a cross-sectional view of one embodiment of a fluid reservoir having a plunger that can be used with the beverage dispenser of FIG. 1A; and

FIG. 5B is a perspective view of the plunger of FIG. 5A.

It is noted that the drawings are not necessarily to scale. The drawings are intended to depict only typical aspects of the subject matter disclosed herein, and therefore should not be considered as limiting the scope of the disclosure.

### DETAILED DESCRIPTION

Certain embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting embodiments and that the scope of the present invention is defined solely by the claims. The features illustrated or described in connection with one embodiment may be combined with the features of other embodiments. Such modifications and variations are intended to be included within the scope of the present invention.

Further, in the present disclosure, like-named components of the embodiments generally have similar features, and thus within a particular embodiment each feature of each like-named component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape.

When carbonating a beverage within a beverage dispenser, several factors contribute to resultant carbonation levels, such as CO2 pressure, retention time, temperature of the fluid, and turbulence of the fluid as it is dispensed. Focusing on temperature, generally higher carbonation levels can be achieved as the fluid temperature is lowered. That is, the colder the fluid to be carbonated the more CO2 can be entrained and retained in the fluid.

It is therefore desirable to chill a base fluid to be carbonated, such as water, prior to the base fluid entering a carbonation system of a beverage machine. This can be accomplished by keeping cold material, such as the frozen base fluid, or ice, adjacent to a fluid intake of the beverage dispenser. Since frozen materials, such as ice, typically float in liquid, a plunger is provided for use with a fluid reservoir to position and maintain the cold material adjacent the reservoir outlet and the beverage machine inlet. In an exemplary embodiment, where the fluid outlet of the reservoir is near a bottom of the reservoir, such a plunger can be used to position and maintain the cold material, such as buoyant ice, near a bottom of the reservoir. This can ensure that fluid leaving the fluid reservoir through the fluid outlet is sufficiently chilled during carbonation of the fluid so as to maximize the carbonation levels of the final beverage. While the subject matter described within is described and illustrated in relation to carbonated beverage dispensers, such subject matter can be applied to other uses where position and/or retention of cold materials proximate to a fluid outlet is needed.

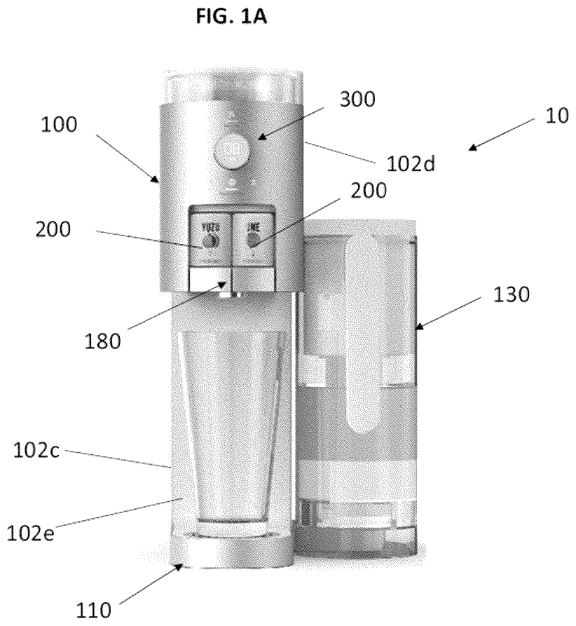

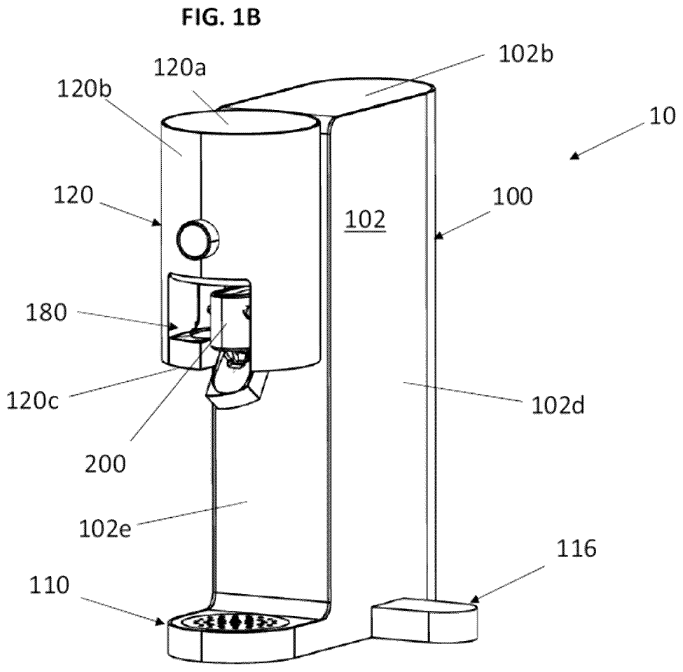

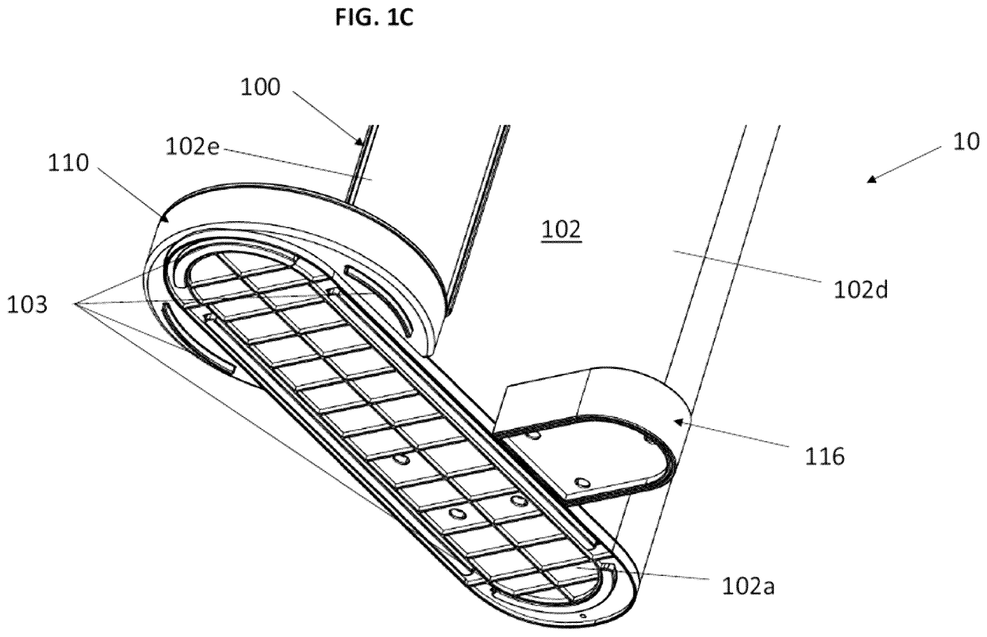

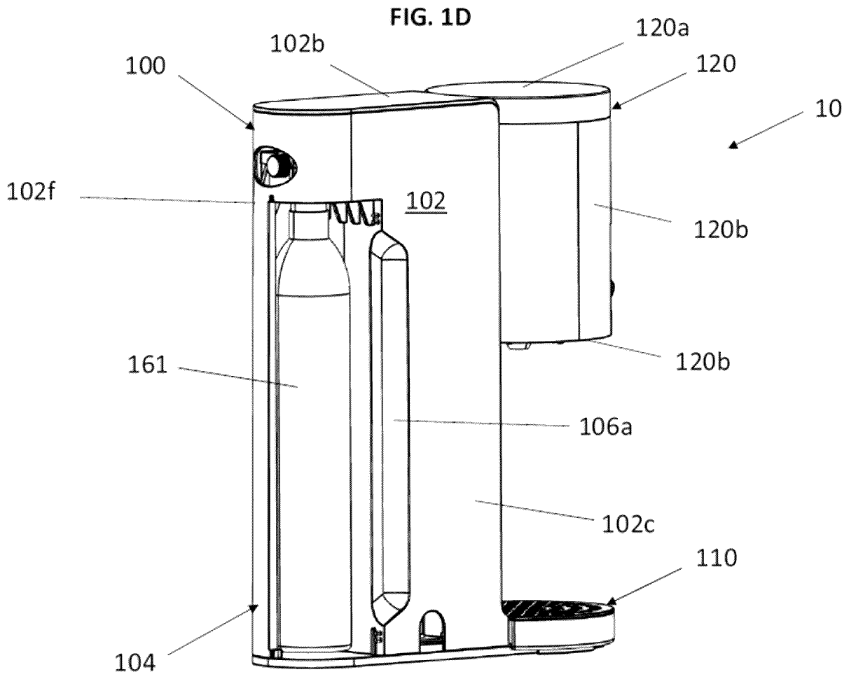

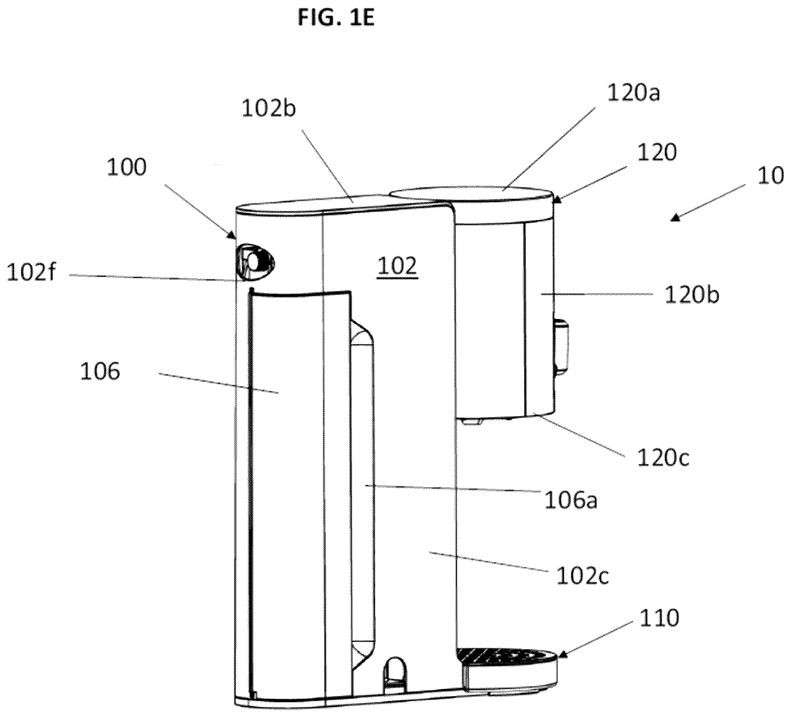

With reference now to FIGS. 1A-1E, an illustrative embodiment of a beverage dispensing device 10 is shown. The illustrated beverage dispensing device 10 generally includes a housing assembly 100 having a carbonation assembly (not shown) disposed therein, a carriage assembly 180 configured to hold one or more flavorant containers 200, and a controller (also referred to as a processor, not shown) with a user interface (UI) 300 for receiving instructions from a user. A fluid reservoir 130 is coupled to the housing assembly 100 and is configured to contain a fluid to be delivered to the carbonation assembly. The housing assembly 100 can also include a drip tray 110 configured to support a container, such as a glass, for collecting fluid. In operation, a user can provide various inputs to the UI and the beverage dispensing device 10 can dispense a carbonated or uncarbonated water, as may be desired, and optionally a flavorant to flavor the carbonated or uncarbonated fluid.

As shown in FIGS. 1A-1E, the illustrated housing assembly 100 includes a housing 102 having an elongate, upright hollow body with top and bottom ends 102a, 102b, a left side 102c, a right side 102d, a front side 102e, and a back side 102f. In the illustrated embodiment, the housing is oblong, and the shape of the housing 102 is longer from the front side 102e to the back side 102f than it is from the left side 102c to the right side 102d. The front side 102e is shown having a flat façade, and the back side 102f is shown having a rounded convex façade, while each of the left and right sides 102c, 102d, is substantially flat. However, the housing 102 can have any shape, and as such, in various embodiments, the shape of the housing 102 can vary to include additional rounded or flat components, or other forms beyond what is shown. The housing 102 can be sized to fit internal components of the beverage dispensing device 10, discussed in further detail below. The housing 102 can be made of any suitable material or materials, and can include various metals (e.g., stainless steel, aluminum), plastics, glass, or other suitable materials known to those skilled in the art, alone or in combination.

The bottom side of the housing 102 can provide the beverage dispensing device 10 with a flat base, and the bottom side can include supports or feet 103 which can provide additional stability. The feet 103 can be in any form, and in one embodiment, as shown in FIG. 1C, the feet are elongate and are disposed around an outer edge of the bottom side 102a. To prevent the housing 102 from sliding on a surface, the feet 103 can be made from a higher-friction material, such as rubber, or have a portion of a higher-friction.

As further shown, the housing 102 includes a head assembly 120 located on an upper portion of the front side 102e of the housing 102. The head assembly 120 can be substantially cylindrical in shape, and includes a top side 120a which aligns with the top side 102b of the housing 102, and a bottom side 120c which includes various openings for dispensing fluids used in the creation of drinks. Between the top side 120a and the bottom side 120c is an outer surface 120b, which defines the rounded form of the cylindrical head assembly 120. The head assembly 120 can contain components of a mixing assembly configured to carbonate fluids (e.g., water), which can then be dispensed from the bottom side. Further, the head assembly 120 can be configured to receive one or more flavorant containers 180, which can be utilized in the creation of beverages. The outer surface 120b of the head assembly 120 can include UI 300 for receiving inputs for operating the device. The mixing assembly, dispensing of fluids, and the creation of beverages, including through operation of the UI 300, will be discussed in greater detail below.

FIG. 1D shows a CO₂ cavity 104 according to the illustrated embodiment. The CO₂ cavity 104 is an opening in the housing, which can receive a CO₂ source used in carbonation processes. In the illustrated embodiment, the CO₂ cavity 104 is located in the rear left side 102c of the housing 102, although the CO₂ cavity 104 can be in other locations. The CO₂ cavity 104 can be closed off by a door 106, as seen in FIG. 1E. The door 106 can extend from the bottom side 102a upward and it can follow a contour of the left side 102c and into the back side 102f. The door 106 can be attached to the housing 102 by a means such as via a hinge or by magnets, or it can be mated using other techniques known in the art. In the illustrated embodiment, the door 106 is wholly removable from the housing 102, but it can be secured to the housing in any of a variety of ways, e.g., by several magnets (not shown) disposed in the door 106 and in the housing 102. A cutaway 106a can be formed in the housing 102, which enables a user to grasp and remove the door 106 while maintaining a uniform shape of the overall housing 102.

The door 106 can be moved between a closed position in which the CO₂ cavity 104 is closed off, and an open position in which the CO₂ cavity 104 is open. When the door 106 is in the open position, the CO₂ source is accessible. In the illustrated embodiment, the CO₂ source is in the form of a canister 161, which will be described in more detail below.

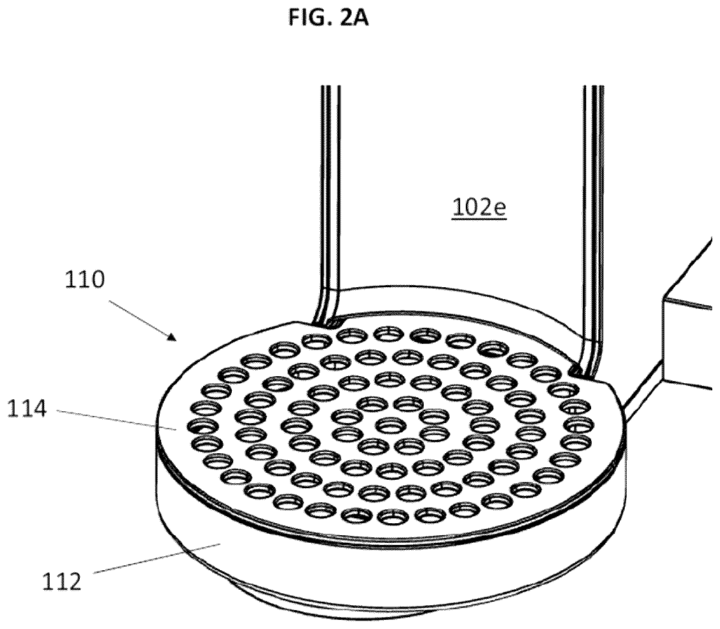

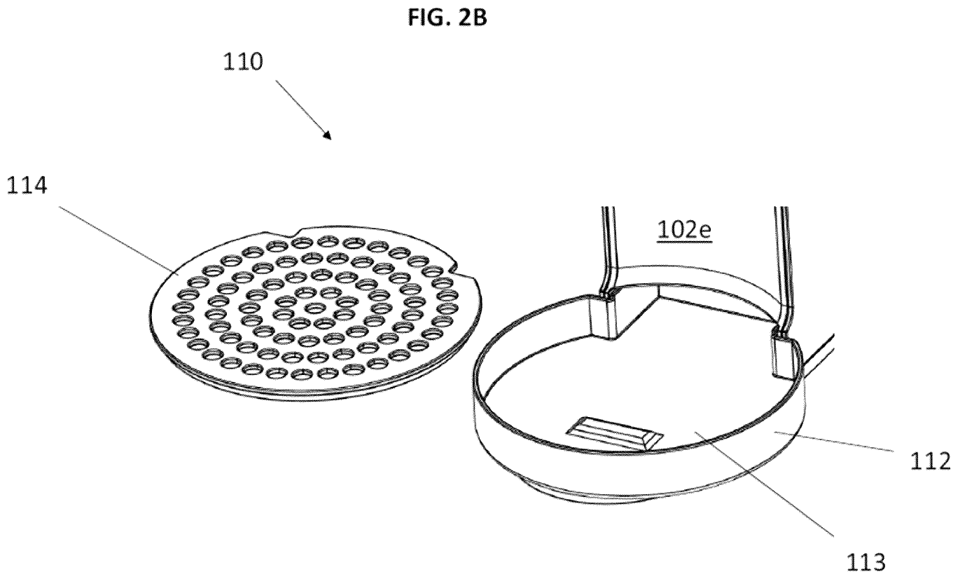

As introduced above, the housing 102 can include a drip tray 110, which can be seen in detail in FIGS. 2A-2B. The drip tray 110 extends from a lower portion of the front side 102e beneath the head assembly 120. The drip tray 110 can have any shape or form, and in the illustrated embodiment, it is flat and round while also corresponding to the size of the head assembly 120. In some embodiments, the drip tray 110 can be integral with the housing 102, while in other embodiments it can be fully removable from the housing 102. Removing the drip tray 110, or not including a drip tray, may allow taller receiving vessels to fit under the head assembly 120. It may also allow for a shorter overall system 10′ having a head assembly with a lower bottom, while still accommodating a same vessel height that can be accommodated with the system 10 and the drip tray 110.

The illustrated drip tray 110 includes a trough 112 defining a central cavity 113, and a grate 114 placed atop the trough 112 and covering the central cavity 113. The grate 114 includes a plurality of holes. During operation of the beverage dispensing device 10, the trough 112 can act to catch and retain splashed or dripping fluid, which can pass through the holes in the grate 114 and can be collected within the central cavity 113. The drip tray 110 can be made of any material, similar to the housing 102, and it can be the same material or a different material as the housing. The trough 112 and the grate 114 can also be made from the same material or from different materials. The trough 112 and grate 114 can be removable from the housing to allow a user to discard any collected fluid. In some embodiments, the system 110 may vent fluid into the drip tray 110 for various purposes, so that it can leave the system 10 as needed without resulting in a mess.

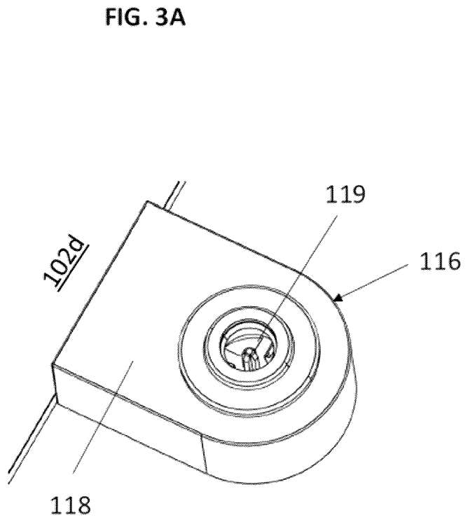

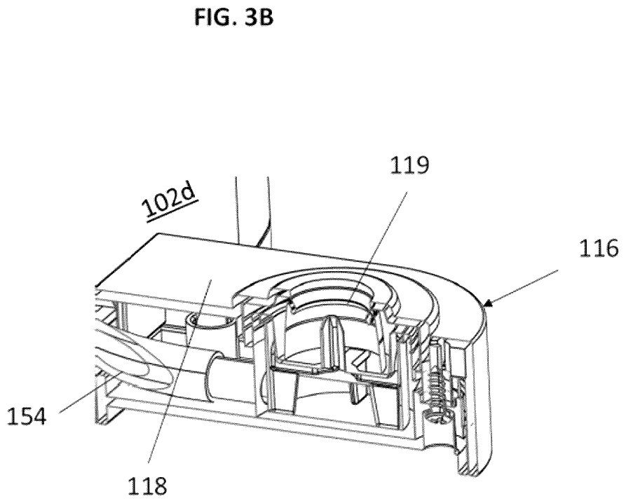

As indicated above, the fluid reservoir 130 can be coupled to the housing 100 for storing fluid to be delivered into the carbonation system. FIGS. 3A-3B illustrate a reservoir valve seat 116 configured to couple the fluid reservoir 130 to the carbonation system. The illustrate reservoir valve seat 116 extends outward from the right side 102d of the housing 102 at the same level as the bottom side 102a. In this manner, the reservoir valve seat 116 can provide extra support to preventing tipping of the beverage dispensing device 10. In other embodiments, the reservoir valve seat 116 can be located at the back side 102e, left side 102c, or in any other location. The reservoir valve seat 116 can be in the form of a hollow housing 118 having an upward extending valve 119. The upward extending valve 119 can be received by a corresponding valve structure located on the bottom side of a water reservoir. FIG. 3B also shows valve 119 coupled to water tubing 154 inside of the reservoir valve seat 116. This tubing 154 can allow fluid to be delivered to the carbonation assembly 150, which will be discussed later in more detail.

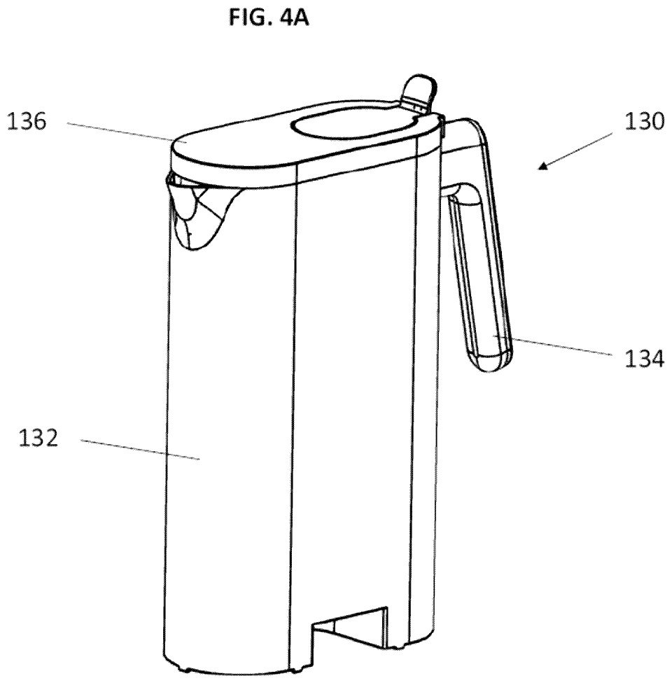

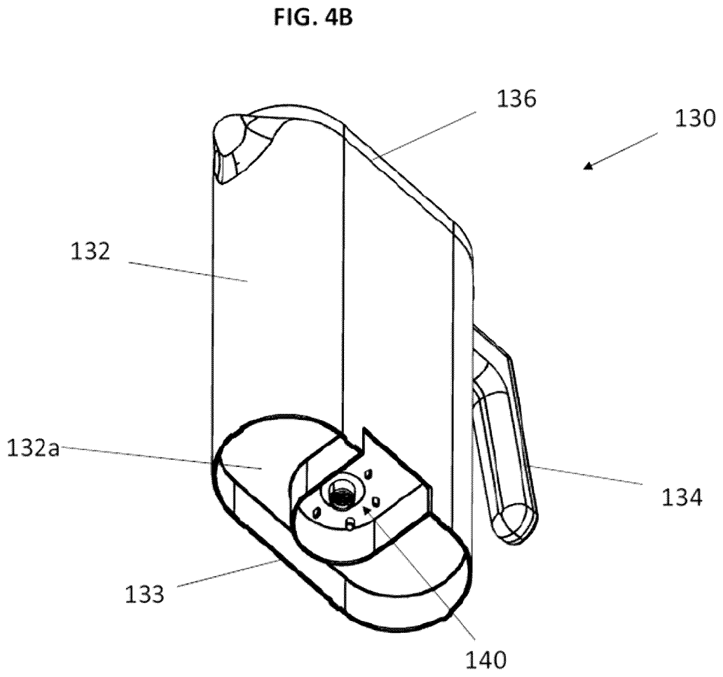

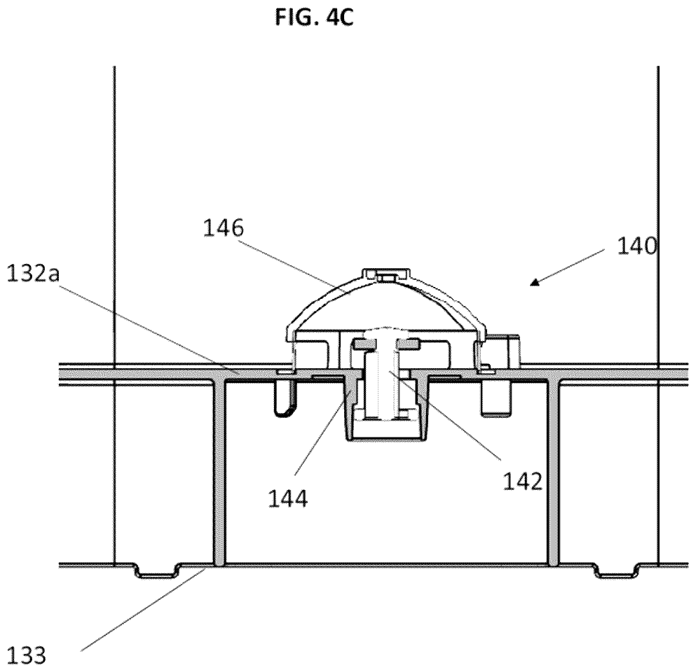

FIGS. 4A-4B show a water reservoir 130 according to an illustrative embodiment. The water reservoir 130, generally, is a container for holding fluid, such as water, which can interface with the reservoir valve seat 116 to thereby enable fluid communication between the water reservoir 130 and the beverage dispensing device 10 for use in the creation and dispensing of beverages. The water reservoir 130 can have any shape, and it can be designed to complement the shape and size of the housing 102. For example, both the water reservoir 130 and the housing 102 can have flat sides to minimize the overall footprint of the system. In the illustrated embodiment, the water reservoir 130 is shown in the form of a pitcher, and it has a main container 132, a handle 134, and a removable lid 136. A bottom side 132a of the container 130 is recessed, and a support 133 extends around the perimeter of the bottom side 132a.

On the bottom side 132a is a valve structure 140 which can be received by the upward extending valve 119 of the reservoir valve seat 116. The valve structure 140 includes a central plug 142 seated within a central valve silo 144. Surrounding an upper extent of the central plug 142, within the water reservoir 130, is a valve guard 146. The valve guard 146 is mounted to the water reservoir 130 and blocks off direct access to the central plug, while still allowing fluid to flow through the valve structure 140. When not received on the upward extending valve 119, the central plug 142 is biased downward within the central valve silo 144 to a closed position to retain fluid in the water reservoir 130. When the valve structure 140 is received on the upward extending valve 119, the central plug 142 can be moved upward within the central valve silo 144 to an open position to allow fluid to flow from the water reservoir 130 through the valve structure 140 and into the rest of the beverage dispensing device 10.

As previously discussed, higher carbonation levels can be achieved if the base fluid within the fluid reservoir 14 is chilled as compared to base fluid held at ambient temperature. For example, if ice, a phase change material, or any other cold material 302 with sufficient heat capacitance is included within the reservoir 300, the temperature of the base fluid will drop to levels associated with greater carbonation. Such augmentation has a greater effect the closer ice or phase change material is to an outlet of the reservoir because the fluid nearest the ice or phase change material will be the coldest within the reservoir 300. In some instances, carbonation levels can be increased by about 20% in comparison to room temperature fluid, which is defined as an about 20% increase in the amount of carbon dioxide dissolved within a given volume fluid, all else being equal.

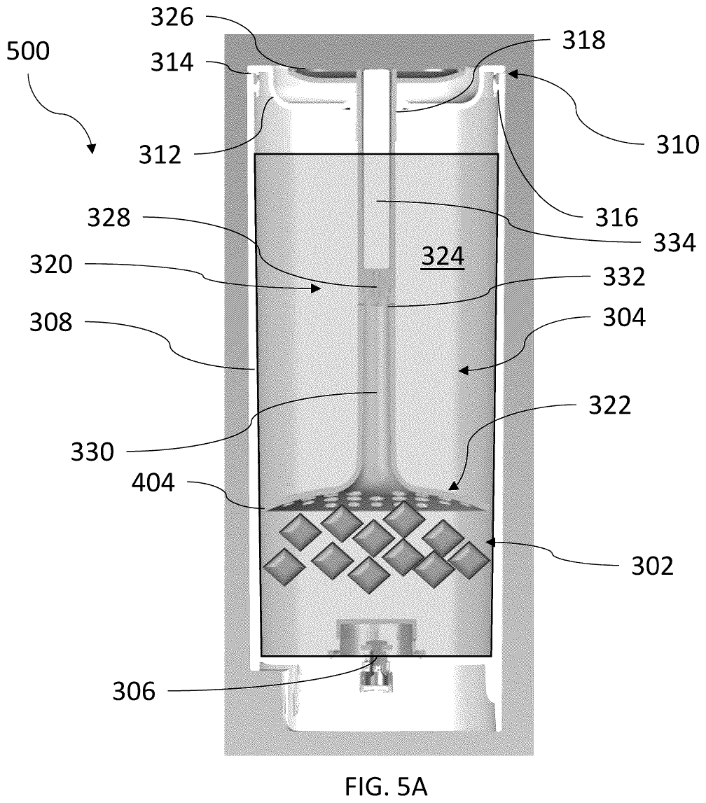

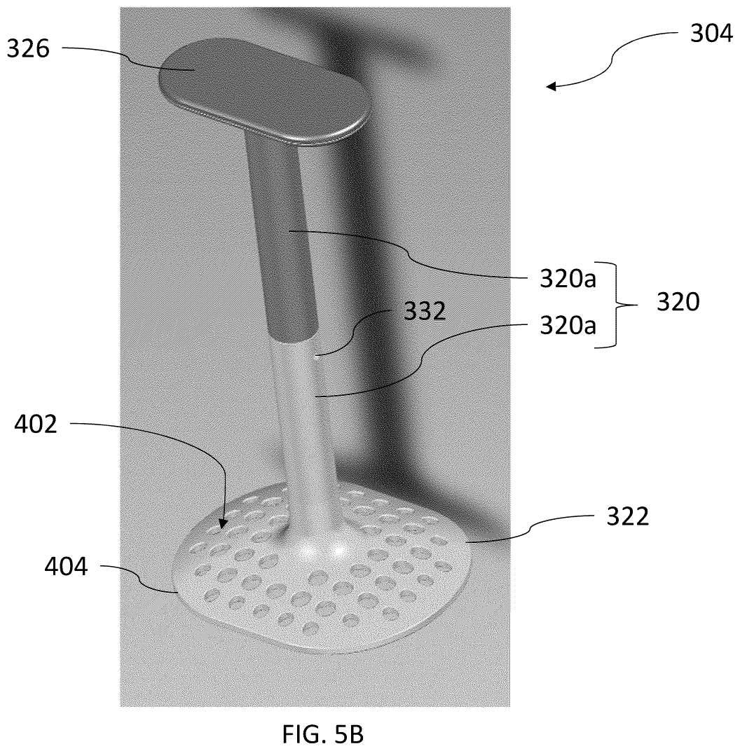

Accordingly, FIG. 5A illustrates a reservoir 500 that includes a plunger 304 configured to position and maintain the cold material nearer a reservoir outlet 306. The reservoir outlet 306 is fluidically coupled to an inlet of the beverage dispensing system 10, for example, by the valve 119. The illustrated reservoir 500 can be used in place of reservoir 130 previously described. As shown, the reservoir 500 generally includes a housing 308 defining a volume to retain a fluid, for example, water. The housing 308 also defines an opening 310 along a top of the housing 308 to receive fluid. A lid 312 can be arranged to cover the opening 310. The illustrated lid defines a shoulder 314 upon which the lid 312 is configured to be supported by the housing 308. In some embodiments, the lid 312 can also include retention springs 316 to help retain the lid 312 to the reservoir. Such retention springs 316 can include, for example, cantilevered portions of plastic biased outward towards the housing 308. In general, the lid helps reduce the likelihood of contaminants from entering the reservoir. In some embodiments, the lid defines a hole 318 therethrough. Such a hole 318 can be arranged and sized to receive and/or retain the plunger 304.

The lid 312 can further include a plunger 304, which in the illustrated embodiment extends through the hole 318. At least the portions of the plunger 304 expected to be submerged (a shaft 320 and a paddle 322) are made of a food-safe material. The plunger can be configured to be vertically movable between a first, upper position and a second, lower position (illustrated) along a length of the plunger 304 relative to the lid 312. In some embodiments, a shaft 320 of the plunger has a smaller cross-sectional area than the hole 318, allowing the plunger to have free movement in the vertical direction with little to no friction between the shaft 320 and the lid 312. In the illustrated embodiment, the plunger has a sufficient mass and average density to sink into the fluid 324 within the reservoir 500, for example, liquid water. In some embodiments, the plunger 304 has sufficient mass to overcome any buoyancy forces presented by the cold material, for example, frozen water, or ice, which is buoyant in liquid water. In some embodiments, the paddle 322 can define a profile 404 that is generally parallel to an interior surface of the housing 308. In some embodiments, a periphery of a paddle 322 of the plunger 304 and an inner wall of the housing 308 can define an annular gap sufficiently small as to keep ice retained on an underside of the paddle 322, while also reducing or eliminating friction between the paddle 322 and the inner wall of the housing 308. In some embodiments, such a gap is between two millimeters and fifteen millimeters.

In general, the plunger is arranged and configured to keep the cold material closer to the outlet 306 that the cold material 302 would otherwise settle. While primarily illustrated as having a fluid outlet along a bottom surface of the reservoir, other positions can be used without departing from this disclosure. For example, in some embodiments the plunger can move along a sidewall of the reservoir. Similarly, while the plunger 304 depicted and described within this disclosure is weighted with a weight 334 to allow for a downward bias, other bias mechanisms and directions can be used without departing from this disclosure. For example, a spring biased plunger can be used to direct cold material towards an outlet along a sidewall of the reservoir. In embodiments with an outlet 306 along a bottom of the housing 308, such a spring can be biased to direct the plunger 304 in a downward direction. Such a spring can include a coiled compression spring, a tension spring, a rubber band or membrane, or any other spring configuration providing sufficient biasing force towards the outlet 306 of the reservoir. Alternatively or in addition, other mechanisms can be used to retain the plunger 304 in a desired position. For example, in some embodiments, latches can be included between the shaft and the lid 312 to retain the plunger in a desired position. Such latches can be directional, for example, allowing freedom of movement of the plunger 304 in a direction towards the outlet 306, but preventing movement in a direction away from the outlet 306 without additional manipulation by a user.

Focusing on the plunger 304, of which FIG. 4 shows a perspective view, the plunger 304 includes a handle 326 at an upper end of the shaft 320. The handle 326 has a larger cross-sectional area than the hole 318, preventing the handle from passing through the hole 318 and those detaching from the lid. In some embodiments, the handle 326 can be sized and shaped as to be ergonomically gripped by a human hand.

At a bottom end of the plunger 304 is the paddle 322. The paddle is likewise sized to prevent passage through the hole in the lid similar to the handle 326. The paddle can have a variety of configurations, but in the illustrated embodiment it is in the form of a plate-like structure. It can be generally planar, or as shown it can be concave on a lower-facing surface to aid in grasping ice or other cold material. The paddle can also be perforated to allow liquid to pass through, for example, as the plunger is moved in relation to the fluid 324. The perforations 402 can reduce drag produced by the paddle 322 as it moves through the fluid. The perforations 402 are sized such that at least a majority of the cold material is retained by the paddle 322. In some embodiments, the perforations can have a diameter between 4 millimeters and 6.5 millimeters, however the size can vary based on the intended size of the cold material. The paddle can also include any number of perforations. In one embodiment, about 50% to 75% of a total surface area of the paddle can be perforated.

The configuration of the shaft can also vary. In one embodiment, the shaft 320 can include an upper shaft 320a connected to the handle 326 and a lower shaft 320b connected to the paddle 322. In some embodiments, the lower shaft 320b and the paddle 322 can be constructed as a single, integrated piece and the upper shaft and the handle 326 can be constructed as a single piece. In other aspects, the upper and lower shafts 320a, 320b can be constructed as a single piece and can be attached or integrally formed with the handle and/or paddle.

In the illustrated embodiment, the upper shaft 320a and the lower shaft 320b are separate components and can be attached to one another with a variety of fasteners, for example, one or more screws 328, a threaded connection, a clip, or a pin. Such fasteners allow the shaft upper shaft 320a and the lower shaft 320b to be separated by a user. Such separation allows for the plunger to be separated from the lid for cleaning, maintenance, or replacement. Alternatively or in addition, adhesives can be used to connect the upper shaft 320a and the lower shaft 320b. In the illustrated embodiment, the lower shaft 320b defines a passage 330 extending between the upper shaft 320a and the lower shaft 320b. More specifically, the passage 330 extends between the paddle 322 and the upper shaft 320a and is defined by the lower shaft 320b. This passage 330 allows for access to the screw 328 that connects the upper shaft 320a and the lower shaft 320b of the example plunger. The lower shaft 320b can also define one or more holes 332 near an upper end of the passage 330 to break a vacuum or release fluid (air or liquid) from the passage 330. The holes 332 can also allow fluid to drain from the passage in the event that the plunger is lifted from or within the reservoir 500. Similarly, the holes 332 can prevent retention of fluid, which could potentially prevent the plunger 304 from sinking within the fluid. In addition to the holes 332, other features can be included to ensure sufficient travel of the plunger, for example, a biasing mechanism. Such a biasing mechanism can be used, for example to increase a weight or density of the plunger. For example, in some embodiments, a weight 334 can be included within the shaft. The weight 334, in combination with the shaft 320, the handle 326, and the paddle 322, can have sufficient weight and density to exert a downward force greater than a buoyancy force of ice within the reservoir.

In the illustrated embodiment, the handle 326 is located above the lid 312, and the shaft 320 extends a distance into the reservoir 500 to the paddle 322. The shaft is of sufficient lengths to allow the paddle to traverse between an upper end of the reservoir 500 and within 25% of the bottom of the reservoir 500. This gap allows sufficient space between the paddle 322 and the outlet 306 as to not interfere with fluid flow from the outlet 306.

In operation, with the lid 312 off, fluid, such as water, is received by the reservoir 500. Ice, or another cold material, is also received by the reservoir 500. For example, the cold material 302 can be a chilled material such as a metal, stone, ceramic, plastic, composite, gel pack, etc., similar to a whiskey stone, ice pack, or the like. The ice or other cold material 302 can be moved towards the outlet 306 of the reservoir 500 by attaching the lid to insert the plunger 304 into the reservoir. The plunger can engage and push the cold material downward when the lid is attached. In some instances, the plunger may encounter resistance and may be forced upward as the lid is attached. In such instances, the user can engage the handle and apply a downward force, causing the paddle to move toward the bottom of the container, engaging and moving the cold material as it is advanced. Resistance will be met once the plunger is fully compressed with the cold material positioned and maintained between the plunger and the bottom of the container. The user can then release the handle, and the bias mechanism, such as the weight 334 will keep the plunger, and therefore the cold material 302, in place. Alternatively or in addition, the latch mechanism previously described can be used to keep the plunger, and therefore the cold material 302, in place. In some instances, the user need not press down on the handle for the paddle to move towards the bottom of the container as the weight 334 provides sufficient downward force to overcome any buoyancy forces of the ice or other cold material 302. The ice or other cold material 302 is then retained proximate to the outlet 306 of the reservoir by the plunger. The fluid 324 can then be directed to flow across the biased and retained cold material 302 and into the beverage dispensing system 10.

Certain illustrative embodiments have been described to provide an overall understanding of the principles of the structure, function, manufacture, and use of the systems, devices, and methods disclosed herein. One or more examples of these embodiments have been illustrated in the accompanying drawings. Those skilled in the art will understand that the systems, devices, and methods specifically described herein and illustrated in the accompanying drawings are non-limiting illustrative embodiments and that the scope of the present invention is defined solely by the claims. The features illustrated or described in connection with one illustrative embodiment may be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

One skilled in the art will appreciate further features and advantages of the invention based on the above-described embodiments. Accordingly, the present application is not to be limited by what has been particularly shown and described, except as indicated by the appended claims. All publications and references cited herein are expressly incorporated by reference in their entirety.

What is claimed is:

1. A reservoir for a beverage machine, the reservoir comprising:
a housing defining a volume to retain a fluid, the housing defining an opening along a top of the housing to receive fluid;
a lid arranged to cover the opening, the lid defining a hole therethrough; and
a plunger comprising:
a shaft extending through the hole;
a handle coupled to a first end of the shaft and positioned above the lid; and
a perforated paddle coupled a second end of the shaft and positioned within the volume of the housing, the shaft of the plunger being vertically slidably movable through the hole defined by the lid to vertically move the perforated paddle within the volume.

2. The reservoir of claim 1, wherein perforations defined by the perforated paddle have a diameter between 4 millimeters and 6.5 millimeters.

3. The reservoir of claim 1, wherein the plunger is configured to move and retain a cold material towards an outlet of the reservoir.

4. The reservoir of claim 1, further comprising a biasing mechanism configured to direct the plunger towards an outlet of the reservoir.

5. The reservoir of claim 4, wherein the biasing mechanism comprises a weight within the shaft, the weight being sufficient to produce a downward force to the plunger that is greater than a buoyancy force of ice within the reservoir.

6. The plunger of claim 1, wherein the shaft comprises:
an upper shaft connected to the handle; and
a lower shaft connected to the perforated paddle, the lower shaft defining a passage extending between the upper shaft and paddle, the lower shaft and the upper shaft being attached to one another by a fastener.

7. The plunger of claim 6, wherein the lower shaft is hollow and defines a hole configured to break a vacuum or to release fluid from the passage.

8. A beverage reservoir comprising:
a housing defining a volume to retain a fluid, the housing defining an opening along a top of the housing to receive fluid; the housing defining a fluid outlet at a bottom of the housing;
a lid a lid arranged to cover the opening; and
a plunger comprising a paddle defining a profile substantially parallel to an inner wall of the housing.

9. The beverage reservoir of claim 8, wherein the plunger is configured to move and retain a cold material proximate the fluid outlet.

10. The beverage reservoir of claim 8, wherein the lid defines a hole.

11. The beverage reservoir of claim 10, wherein the plunger further comprises:
a shaft extending through the hole, the shaft having a diameter less than that of the hole, the shaft being vertically slidably movable through the hole to vertically move the paddle within the volume; and
a handle at an upper end of the shaft, the handle having a larger cross-sectional area than the hole.

12. The plunger of claim 11, further comprising a biasing mechanism configured to direct the plunger towards the fluid outlet at the bottom of the housing.

13. The plunger of claim 12, wherein the biasing mechanism comprises a weight within the shaft, the weight, providing a downward force greater than a buoyancy force of ice within the housing.

14. The plunger of claim 11, wherein the shaft comprises:
an upper shaft connected to the handle; and
a lower shaft connected to the paddle, the lower shaft defining a passage extending between the upper shaft and paddle, the lower shaft and the upper shaft attached to one another by a fastener.

15. The plunger of claim 14, wherein the lower shaft is hollow and defines a hole configured to break a vacuum or to release fluid from the passage.

16. The Plunger of claim 8, wherein the paddle includes a plurality of perforations.
